(19) United States
(12) Patent Application Publication
(10) Pub. No.: US 2026/0131497 A1
(43) Pub. Date: May 14, 2026

(54) METHOD FOR PRODUCING MODIFIED WOOD MATERIAL, AND MODIFIED WOOD MATERIAL

(71) Applicants: KYOTO PREFECTURAL PUBLIC UNIVERSITY CORPORATION, Kyoto-shi (JP); Keihoku Precut Co., Ltd., Kyoto-shi (JP)

(72) Inventors: Takafumi ITOH, Kyoto-shi (JP); Hisashi MIYAFUJI, Kyoto-shi, (JP); Keisuke KOJIRO, Kyoto-shi (JP); Yuzo FURUTA, Kyoto-shi (JP); Hiroaki HORIYAMA, Kyoto-shi (JP); Toshiya AKI, Kawanishi-shi (JP)

(21) Appl. No.: 19/385,419

(22) Filed: Nov. 11, 2025

(30) Foreign Application Priority Data
Nov. 13, 2024 (JP) 2024-198034

(51) Int. Cl. B27K 3/08; B27K 3/34; B27K 5/00; B27K 5/04

(52) U.S. Cl. CPC B27K 3/08; B27K 3/34; B27K 5/001; B27K 5/04; B27K 2200/10

(57) ABSTRACT

The present invention relates to a method for producing a modified wood material comprising:
1) step of impregnating an untreated wood material with at least one acid selected from citric acid, malic acid and glutaric acid, and glycerin to obtain a chemical-impregnated wood material; and
2) step of heating the chemical-impregnated wood material obtained in step 1.

### CROSS-REFERENCE TO RELATED APPLICATION

This application claims priority to Japanese Patent Application No. 2024-198034, filed on Nov. 13, 2024, the disclosure of which is hereby incorporated by reference in its entirety.

### BACKGROUND OF THE INVENTION

### Field of the Invention

The present disclosure relates to a method for modifying wood material, namely, a method for producing a modified wood material. In addition, the present disclosure relates to a modified wood material produced by the production method of the present disclosure.

### Description of the Related Art

Various methods are known as methods for modifying wood materials. For example, to improve dimensional stability, rot resistance, etc. of wood materials, it is known to treat wood materials with polyalcohol and poly carboxylic acid.

Wood materials are used for exterior components such as wood decks, exterior walls, louvers, and wood fences, but these applications particularly require high durability and dimensional stability. An object of the present disclosure is to provide a method for producing a modified wood material with high dimensional stability.

### SUMMARY OF THE INVENTION

The present disclosure provides the following aspects.

(Embodiment 1) A method for producing modified wood material including:
1) step of impregnating an untreated wood material with at least one acid selected from citric acid, malic acid and glutaric acid, and glycerin to obtain a chemical-impregnated wood material; and
2) step of heating the chemical-impregnated wood material obtained in step 1.

(Embodiment 2) The production method according to Embodiment 1, wherein a molar ratio of the glycerin to the total number of carboxyl groups of the acid is 0.1 to 0.50.

(Embodiment 3) The production method according to Embodiment 1, wherein the acid is citric acid and a molar ratio of the glycerin to the citric acid is 0.5 to 1.4.

(Embodiment 4) The production method according to any one of items 1 to 3, wherein step 1 is step of impregnating the untreated wood material with an aqueous solution containing glycerin and the acid.

(Embodiment 5) The production method according to Embodiment 4, wherein a total concentration of the acid and glycerin in the aqueous solution is 10% by mass or more.

(Embodiment 6) The production method according to Embodiment 4, wherein a total concentration of the acid and glycerin in the aqueous solution is 40% by mass or less.

(Embodiment 7) The production method according to any one of items 1 to 6, wherein the acid is citric acid.

(Embodiment 8) The production method according to any one of items 1 to 7, wherein a heating temperature in step 2 is 130 to 180° C.

(Embodiment 9) The production method according to any one of items 1 to 8, wherein the wood material is softwood.

(Embodiment 10) The production method according to any one of items 1 to 9, wherein the wood material is Cryptomeria japonica or Chamaecyparis obtusa.

(Embodiment 11) The production method according to any one of items 1 to 10, further including impregnation with a polyol in step 1.

(Embodiment 12) The production method according to Embodiment 11, wherein the polyol is PEG200 or PEG400.

(Embodiment 13) A modified wood material produced by the production method according to any one of items 1 to 12.

(Embodiment 14) A modified wood material including at least one acid selected from citric acid, malic acid and glutaric acid, and glycerin.

(Embodiment 15) The modified wood material according to Embodiment 13 or 14, used for floor materials, decks, exterior wall materials, louvers, furniture, wooden fences, guardrails, exterior construction materials, and/or musical instruments.

According to the present disclosure, a method for producing a modified wood material with high dimension stability can be provided.

### DETAILED DESCRIPTION OF THE INVENTION

Hereinafter, a production method according to the present disclosure will be described.

The production method of the present disclosure modifies wood material, providing a modified wood material. Accordingly, the production method of the modified wood material of the present disclosure can also be referred to as a method for modifying wood material. According to the production method of the present disclosure, dimensional stability of the wood material can be improved. Furthermore, according to the production method of the present disclosure, the termite and decay resistance of the wood material can be improved.

In recent years, research on the effective use of wood materials for further new applications has advanced. For instance, using wood materials for exterior components, such as wood decks, exterior walls, louvers, and wood fences, has gained attention. However, for these applications, the wood materials are primarily used in harsh environments such as outdoor, thus dimensional stability and durability are required. Particularly, since softwood is less durable than hardwood which has conventionally been used for exterior applications such as wood decks (hereinafter simply referred to as “hardwood”), it is necessary to enhance the durability of softwood when using it as an alternative to the hardwood. In addition, the hardwood is used for its high durability and hardness, but it has dimensional stability issues. The same is true for softwood, and when used in harsh environments such as outdoors, it may warp and/or crack, often resulting in a service life shorter than expected, and therefore, improving dimensional stability is crucial.

The production method of present disclosure achieves the solution of the issue that softwood is relatively less durable than, for example, the hardwood, and imparting higher dimensional stability to prevent cracking and warping by modifying wood materials using at least one acid selected from citric acid, malic acid and glutaric acid, and glycerin.

These effects are not particularly bound by theory, but these are believed to be caused by the reaction of acid and glycerin, resulting in resinification in wood material, or by the reaction of acid, and hydroxyl groups in wood components.

### [Production Method of Modified Wood Material]

The production method of the modified wood material of the present disclosure includes:
1) step of impregnating an untreated wood material with at least one acid selected from citric acid, malic acid and glutaric acid, and glycerin to obtain a chemical-impregnated wood material; and
2) step of heating the chemical-impregnated wood material obtained in step 1.

### (Step 1)

In step 1, an untreated wood material is impregnated with at least one acid selected from citric acid, malic acid and glutaric acid, and glycerin to obtain a chemical-impregnated wood material. In the present specification, the above acids and glycerin are sometimes referred collectively to as a “chemical”.

The above acid may be one type or a mixture of two or more types, but it is preferably one type. The above acid is preferably citric acid. Treating untreated wood material with this acid in combination with glycerin yields the modified wood material with high dimensional stability.

A method for impregnating wood material with the above acid and glycerin is not particularly limited, but it is preferable that the untreated wood material be treated with a solution containing the acid and glycerin.

The above treatment is performed by immersing the untreated wood material in a solution containing chemicals, or by spraying or coating the untreated wood material with the solution containing chemicals. Preferably the above treatment is performed by immersing the untreated wood material in the solution containing chemicals. The above immersing treatment is preferably performed by immersing the untreated wood material in the solution containing chemicals under a reduced and/or pressurized condition, the so-called reduced/pressurized impregnation method.

The above reduced pressure condition may depend on the shape and/or size of the untreated wood material to be modified, but it may be, for example, a pressure lower than atmospheric pressure, such as 1 to 100 hPa, 10 to 80 hPa, 20 to 60 hPa, or 30 to 50 hPa. Under these reduced pressure conditions, penetration of the solution into the untreated wood material is more accelerated.

The above pressurized condition may depend on the shape and/or size of the untreated wood material to be modified, but it may be, for example, a pressure higher than atmospheric pressure, such as 0.1 to 3 MPa, 0.3 to 2 MPa, or 0.3 to 1.5 MPa.

When the untreated wood material is immersed in the solution containing the above chemicals, the solution's temperature can be, for example, ordinary temperature, preferably 20 to 30° C. or 23 to 27° C.

The term “ordinary temperature” in the present disclosure is referred to as the temperature of an environment in which one of ordinary skill in the art does not artificially change the temperature by heating, cooling, or the like (e.g., ambient temperature), and can be typically 15 to 35° C., such as 20 to 30° C. or 23 to 27° C., specifically 25° C.

A time for immersing the untreated wood material in the solution may depend on the shape and/or size of the untreated wood material to be modified, but it may be, for example, 5 minutes to 16 hours, such as 30 minutes to 16 hours, 1 to 16 hours, 1 to 8 hours, 1 to 4 hours, or 1 to 3 hours.

An example of the above reduced/pressurized impregnation method involves performing the following sequence of steps: reducing pressure, releasing pressure, pressurizing, and releasing pressure. Reducing pressure is performed at 30 to 50 hPa for 1 to 2 hours, for example. Pressurizing may be performed in steps, at 0.3 MPa for 0.5 to 1 hour, 0.5 MPa for 0.5 to 1 hour, 0.8 MPa for 1 to 4 hours, 1.0 MPa for 1 to 4 hours, 1.3 MPa for 1 to 4 hours, and 1.5 MPa for 1 to 24 hours, for example. These conditions can be appropriately changed depending on the size, type, and the like, of the untreated wood material. For example, the above pressurizing protocol may be stopped along the way.

The solution containing acid and glycerin is preferably an aqueous solution. Using an aqueous solution makes preparation easier and more environmentally friendly.

In the present invention, the type of water used as the solvent of the aqueous solution is not particularly limited, and it can be used if it is generally recognized as water. This is merely an example, but the water may be at least one selected from the group consisting of tap water, purified water, groundwater, river water, rainwater, deionized water, distilled water, etc.

In the preferable aspect, the solution containing the above chemicals does not contain an organic solvent.

A total concentration of acid and glycerin in the above solution is preferably 10% by mass or more, more preferably 15% by mass or more, and even more preferably 20% by mass or more, such as 25% by mass or more. Setting the total concentration of acid and glycerin in the above solution within the above range improves chemical retention.

The total concentration of acid and glycerin in the above solution is preferably 50% by mass or less, more preferably 40% by mass or less, and even more preferably 35% by mass or less. Setting the total concentration of acid and glycerin in the above solution within the above range improves the AES of the wood specimens treated with chemicals. The dimensional stability can also be improved.

The total concentration of acid and glycerin in the above solution can be preferably 10 to 50% by mass, more preferably 15 to 40% by mass, even more preferably 20 to 50% by mass, and still more preferably 25 to 40% by mass, such as 10 to 40% by mass, 15 to 35% by mass, or 15 to 30% by mass. Setting the total concentration of acid and glycerin in the above solution within the above range improves chemical retention in the treated wood material and dimensional stability.

A molar ratio of glycerin to the total number of carboxyl groups of the acid (glycerin/carboxyl group) can be preferably 0.1 to 0.5, more preferably 0.15 to 0.4, and even more preferably 0.2 to 0.4. The modified wood material may lose weight through a process consisting of three repetitions of the following operations: impregnation under reduced pressure with water, followed by immersion in water for 24 hours and blow drying at 105° C. for 24 hours (hereinafter referred to as a “leaching operation”). This weight loss is believed to be due to the leaching of unreacted glycerin and/or acid after the reaction. Setting the molar ratio of glycerin to the total number of carboxyl groups of the acid within the above range quantitatively proceeds the reaction of acid and glycerin, thereby reducing the weight loss rate of the modified wood material, i.e., reducing the amount of unreacted material.

When the acid is citric acid preferably, the molar ratio of glycerin to citric acid (glycerin/citric acid) is preferably 0.5 to 1.4, more preferably 0.7 to 1.2, even more preferably 0.8 to 1.2, still more preferably 1.0 to 1.2, and particularly preferably 1.05 to 1.15, and it can be specifically about 1.1.

When the acid is malic acid or glutaric acid preferably, the molar ratio of glycerin to malic acid or glutaric acid (glycerin/malic acid or glutaric acid) is preferably 0.3 to 1.0, more preferably 0.4 to 0.8, even more preferably 0.5 to 0.7, and it can be specifically about 0.67.

In one aspect, step 1 may further include impregnation with a polyol.

The above polyol is not particularly limited, but it may be, for example, polyethylene glycol, such as PEG200 or PEG400.

### (Step 2)

In step 2, the chemical-impregnated wood material obtained in step 1 is heated. The glycerin and acid impregnated into the chemical-impregnated wood material react by heating. In addition, some of the acid reacts with hydroxyl groups in the wood material components. It is believed that this modifies the wood material and proceeds with so-called resin composite formation.

The heating in step 2 is not particularly limited to any specific method if it can raise the temperature of the chemical-impregnated wood material. For example, the heating in step 2 may be performed by raising the temperature of the chamber in which the chemical-impregnated wood material is placed (e.g., the temperature of the atmosphere inside the chamber).

The above heating temperature can be preferably 100 to 180° C., more preferably 130 to 180° C., even more preferably 140 to 180° C., and still more preferably 150 to 170° C. Increasing the above heating temperature improves the reaction rate of chemicals and shortens the treatment time. In addition, the chemical leaching ratio declines. On the other hand, lowering the above heating temperature improves the chemical retention. This is believed to prevent the chemicals from decomposing or evaporating.

Heating time in step 2 may be typically 2 to 240 hours, such as 4 to 168 hours, 4 to 96 hours, 10 to 96 hours, 10 to 80 hours, 10 to 48 hours, 4 to 48 hours, 4 to 30 hours, 10 to 30 hours, 4 to 24 hours, 4 to 10 hours, or 4 to 8 hours.

Heating in step 2 may be performed in an air atmosphere, but this is not limited to it. For example, when heating to a relatively high temperature (e.g., heating to a higher temperature than 200° C.), it may be performed in a steam and/or an inert gas atmosphere such as nitrogen.

In or after the heating of step 2, the wood material may be dried. For example, the impregnated glycerin and acid may react in the wood material by the heating in step 2, which also dries the wood material.

The wood material that is the subject of the production method of the present disclosure is not particularly limited and may be any substance that is equivalent to, as it is called, wood material. For example, the wood material that is the subject of the production method of the present disclosure is softwood and includes at least one softwood selected from the group consisting of Cryptomeria japonica, Chamaecyparis obtusa, Pinus, Larix kaempferi, Picea jezoensis var. jesoensis, Abies sachalinensis, Tsuga sieboldii, Abies firma, southern yellow pine, Pinus radiata, Pinus sylvestris, Cunninghamia lanceolata, Douglas fir, etc. Furthermore, the wood material that is the subject of the production method of the present disclosure may include solid wood from fast-growing but soft broad-leaved trees such as Populus and/or Melia azedarach, as well as wood materials that have been processed to some extent, such as bonded wood, plyboard, single panel, particleboard and/or fiberboard, and the materials constituting them, such as, laminates (sawn boards), single panel, wood chips, wood flour, and/or wood fibers (pulps), and further non-wood lignocellulosic materials such as bamboo.

In a preferable aspect, the wood material is softwood. In that case, the effects of the present invention can be more pronounced. These wood materials originally have limited applications due to their low durability and/or hardness (partial compression strength), but the production method of the present disclosure improves their properties, enabling them to be used in a wider range of applications.

In one aspect, the untreated wood material to be modified can be a wood material having a moisture content adjusted to 30% by weight or less based on the total weight of the wood material, such as 25% by weight or less, 20% by weight or less, or 15% by weight or less (a lower limit in this case may be a value of 0% by weight or more).

The modified wood materials modified by the production method of the present disclosure are used for a variety of indoor and/or outdoor applications, preferably for outdoor applications. For example, The modified wood materials modified by the production method of the present disclosure can be used for floor materials, decks, exterior wall materials, louvers, furniture, wooden fences, guardrails, exterior construction materials, and/or musical instruments.

### [Modified Wood Material]

The present disclosure provides a modified wood material produced by the production method of the modified wood material of the present disclosure. This modified wood material contains a reaction product of at least one acid selected from citric acid, malic acid and glutaric acid, and glycerin.

The modified wood material of the present invention can have at least one of the following physical properties.

### (Chemical Retention)

Chemical retention of 50 to 100%, such as 60 to 90%, 70 to 90%, or 70 to 80%.

$$Chemical retention ( \% ) = \{ ( Oven - dry mass of modified wood material - Oven - dry mass of untreated wood material ) / ( Mass of chemicals impregnated in chemical - impregnated wood material \times Concentration of chemicals ( \% by mass ) / 100 ) \} \times 100$$

### (Chemical Leaching Ratio)

Chemical leaching ratio of 10% or less, such as 0.1 to 5%, or 0.5 to 3%.

$$Chemical leaching ratio = 1 - ( Oven - dry mass of modified wood material after leaching operation - Oven - dry mass of untreated wood material ) / ( Oven - dry mass of modified wood material - Oven - dry mass of untreated wood material ) \} \times 100$$

### (Weight Percent Gain/WPG)

Weight percent gain (WPG) of 20 to 100%, such as 25 to 90%, 30 to 90%, or 40 to 90%.

$$Weight percent gain ( WPG ) ( \% ) = [ ( {W}_{t} - {W}_{o} ) / Wo ] \times 100 ,$$

wherein Wₜ is Oven-dry mass (g) of modified wood material and Wo is Oven-dry mass (g) of untreated wood material.

### (Bulking/B)

Bulking (B) (%) of 1 to 10%, such as 1.5 to 5%, or 2 to 3%.

$$Bulking ( B ) ( \% ) = [ ( {S}_{t} - {S}_{o} ) / {S}_{o} ] \times 100 ,$$

wherein Sₜ is Cross-sectional area (mm²) of modified wood material in Oven-dry state, Sₒ is Cross-sectional area (mm²) of untreated wood material in Oven-dry state.

### (Dimensional Stability (Anti-Swelling Efficiency)/ASE)

ASE of 50% or more, such as 50 to 70%, 55 to 70%, or 55 to 65%.

$$Anti - Swelling Efficiency ( ASE ) ( \% ) = [ ( {S}_{c} - {S}_{t} ) / {S}_{c} ] \times 100 ,$$

wherein Sₜ is Cross-sectional relative swelling (%) of modified wood material after moisture absorption or water absorption under specified conditions from Oven-dry state, and Sc is Cross-sectional relative swelling (%) of untreated wood material after moisture absorption or water absorption under the same conditions as that of the modified wood material from Oven-dry state.

Anti-swelling efficiency, ASE, is an indicator representing dimensional stability. It is preferable for the practical use of modified wood material when ASE is 50% or more, while it is not preferable when ASE is less than 50%.

Here, “oven-dry” and “oven-dry state” in the present specification are referred to as a state of the wood material when modified wood material or untreated wood material is placed in a constant temperature oven (type: DN43, produced by Yamato Scientific Co., Ltd.) of which a temperature is set to 105° C., and no further weight change occurs. In addition, an oven-dry weight is the weight of material when no further weight change occurs.

### (Partial Compression Strength)

Partial compression strength of the modified wood material measured according to the following testing method is preferably 1.4 times or more that of the untreated wood material, such as 1.5 to 3 times, or 1.6 to 2.5 times.

After adjusting moisture of the modified wood material, the partial compression strength test is performed using a Universal Testing Machine (AUTOGRAPH) produced by Shimadzu Corporation in accordance with JIS Z 2101. The tests are performed at a head speed of 1 mm/min, using a flat grain face and a straight grain face as the compression surfaces.

The values of the partial compression strength obtained from these tests performed in accordance with JIS Z 2101 are compared between the states before and after the modification. Specifically, the ratio of the partial compression strength of the modified wood material to that of the untreated wood material is calculated (the value of partial compression strength (times)=the partial compression strength of the modified wood material/the partial compression strength of the untreated wood material).

Furthermore, as can be seen from this testing method, this partial compression strength serves as an indicator of hardness of the wood material. When the value of this partial compression strength (ratio) is 1.4 times or more, the modified wood material is preferable for practical uses (various actual applications).

### (Durability/Decay Resistance·Rot Resistance)

An average mass loss ratio obtained in accordance with 5.2.1.1 For Injection Treatment, 5.2.1 Laboratory Testing, 5.2 Preservative Performance, in JIS K 1571 “Wood preservatives-Performance requirements and their test methods for determining effectiveness”, is 3% or less.

As a more specific method, after inoculating the modified wood material with fungi (test fungi: Fomitopsis palustris and Trametes versicolor), the modified wood material is placed in an environment with a temperature of 26±2° C. and a relative humidity of 70% or more for 12 weeks. Then the average mass loss ratio of the modified wood material is calculated based on the weight change between the states before and after this treatment.

When this average mass loss ratio is 3% or less, the modified wood material is preferable for practical use (various actual applications).

### EXAMPLES

The production method of the modified wood material of the present invention will be described more specifically by way of the following Examples, but the present invention is not limited to these Examples.

### Examples 1 to 6 and Comparative Examples 1 to 3

As shown in the following table, various wood specimens were immersed in a solution containing chemicals (hereinafter referred to as a “chemical solution”) and the chemical solution was allowed to penetrate sufficiently into the wood specimens using the reduced/pressurized impregnation. Then the wood specimens were taken out of the chemical solution and heat treated using a blower dryer. In more detail, the wood specimens were immersed in the chemical solution and subjected to a reduced pressure of about 50 hPa at ordinary temperature for 2 hours, followed by a pressure of 1.0 MPa for 1 hour, and then taken out of the chemical solution after releasing pressure. Then they were dried using the blower dryer at 60° C. for 48 hours, followed by 105° C. for 48 hours. The dried wood specimens were heated at a predetermined temperature for 4 hours to allow the chemicals to react.

TABLE 1

| | | | Concentration of | | |
|---|---|---|---|---|---|
| | | Molar | Chemicals | Heating | Wood |
| | Chemicals | Ratio | (% by mass) | Temperature | Material |
| Example 1 | Citric Acid:Glycerin | 2:1 | 20% | 150° C. | Cryptomeria |
| | | | | | japonica |
| Example 2 | Citric Acid:Glycerin | 2:1 | 20% | 160° C. | Cryptomeria |
| | | | | | japonica |
| Example 3 | Citric Acid:Glycerin | 2:1 | 20% | 170° C. | Cryptomeria |
| | | | | | japonica |
| Example 4 | Citric Acid:Glycerin | 1:1 | 20% | 150° C. | Cryptomeria |
| | | | | | japonica |
| Example 5 | Citric Acid:Glycerin | 1:1 | 20% | 160° C. | Cryptomeria |
| | | | | | japonica |
| Example 6 | Citric Acid:Glycerin | 1:1 | 20% | 170° C. | Cryptomeria |
| | | | | | japonica |
| Comparative | Citric Acid | — | 20% | 150° C. | Cryptomeria |
| Example 1 | | | | | japonica |
| Comparative | Citric Acid | — | 20% | 160° C. | Cryptomeria |
| Example 2 | | | | | japonica |
| Comparative | Citric Acid | — | 20% | 170° C. | Cryptomeria |
| Example 3 | | | | | japonica |

For each specimen, the chemical retention, chemical leaching ratio, weight percent gain, bulking and ASE were measured. In addition, the bulking and ASE were measured before and after an operation that repeats the water absorption and drying three times.

TABLE 2

| | Chemical | Chemical | Weight Percent | Bulking | ASE |
|---|---|---|---|---|---|
| | Retention | Leaching Ratio | Gain | Initial/Repetition | Initial/Repetition |
| | (%) | (%) | (%) | (%) | (%) |
| Example 1 | 79.2 | 9.5 | 48.8 | 6.37/5.58 | 53.0/48.9 |
| Example 2 | 76.0 | 5.6 | 46.5 | 6.18/5.58 | 56.2/52.2 |
| Example 3 | 68.0 | 1.9 | 41.3 | 5.60/5.23 | 61.8/56.2 |
| Example 4 | 78.3 | 7.9 | 47.9 | 6.75/5.77 | 58.1/48.3 |
| Example 5 | 76.7 | 5.0 | 46.6 | 6.57/6.01 | 57.6/52.5 |
| Example 6 | 71.5 | 1.2 | 43.6 | 6.23/5.75 | 62.7/57.9 |
| Comparative | 57.7 | 27.3 | 35.6 | 6.26/5.39 | 58.5/53.1 |
| Example 1 | | | | | |
| Comparative | 52.6 | 17.4 | 32.3 | 5.85/5.24 | 58.9/54.3 |
| Example 2 | | | | | |
| Comparative | 41.3 | 5.5 | 25.3 | 5.20/4.93 | 61.8/58.1 |
| Example 3 | | | | | |

From the above results, it was confirmed that the wood specimens treated with a combination of citric acid and glycerin had high chemical retention, a low chemical leaching ratio, and a high weight percent gain.

### Examples 7 to 9

The wood specimens were treated in the same manner as Examples 4 to 6, except that the heating time of the dried wood specimens at a predetermined temperature was changed from 4 hours to 24 hours. For each specimen, the chemical retention, chemical leaching ratio, weight percent gain, bulking, and ASE were measured.

TABLE 3

| | Chemical | Chemical | Weight Percent | Bulking | ASE |
|---|---|---|---|---|---|
| | Retention | Leaching Ratio | Gain | Initial/Repetition | Initial/Repetition |
| | (%) | (%) | (%) | (%) | (%) |
| Example 7 | 73.9 | 2.8 | 44.7 | 6.05/5.50 | 59.0/54.6 |
| Example 8 | 69.3 | 1.4 | 42.0 | 5.65/5.16 | 62.9/57.9 |
| Example 9 | 63.8 | 0.8 | 38.5 | 5.01/4.58 | 63.6/57.9 |

From the above results, it was confirmed that the wood specimens treated for 24 hours had high chemical retention, a low chemical leaching ratio, and a high weight percent gain. Furthermore, high ASE was also confirmed. Considering these results comprehensively, it was demonstrated that the treatment at 160° C., which showed excellent results in all indexes, was optimal.

### Examples 10 to 14 and Comparative Examples 4 to 7

As shown in the following table, Cryptomeria japonica woods were immersed in the chemical solution and the chemical solution was allowed to penetrate sufficiently into the wood specimens using the reduced/pressurized impregnation. Then the wood specimens were taken out of the chemical solution and heat treated using a blower dryer. In more detail, the wood specimens were immersed in the chemical solution and subjected to a reduced pressure of about 50 hPa at ordinary temperature for 2 hours, followed by a pressure of 1.0 MPa for 1 hour, and then taken out of the chemical solution after releasing pressure. Then they were dried using the blower dryer at 60° C. for 48 hours, followed by 105° C. for 48 hours. The dried wood specimens were heated at a predetermined temperature for 24 hours to allow the chemicals to react.

TABLE 4

| | | | Concentration of | |
|---|---|---|---|---|
| | | | Chemicals | Heating |
| | Chemicals | Molar Ratio | (% by mass) | Temperature |
| Example 10 | Citric Acid:Glycerin | 1:1 | 16.7% | 160° C. |
| Example 11 | Glutaric Acid:Glycerin | 1:1 | 16.7% | 160° C. |
| Example 12 | Glutaric Acid:Glycerin | 3:2 | 16.7% | 160° C. |
| Example 13 | Malic Acid:Glycerin | 1:1 | 16.7% | 160° C. |
| Example 14 | Malic Acid:Glycerin | 3:2 | 16.7% | 160° C. |
| Comparative Example 4 | Malonic Acid:Glycerin | 1:1 | 16.7% | 160° C. |
| Comparative Example 5 | Malonic Acid:Glycerin | 3:2 | 16.7% | 160° C. |
| Comparative Example 6 | Tartaric acid:Glycerin | 1:1 | 16.7% | 160° C. |
| Comparative Example 7 | Tartaric acid:Glycerin | 3:2 | 16.7% | 160° C. |

For each specimen, the chemical retention, shrinkage ratio, and after repeating the water absorption and drying three times, the chemical leaching ratio and ASE, were measured.

TABLE 5

| | Chemical Retention | Shrinkage Ratio | Leaching Ration | ASE | Score | |
|---|---|---|---|---|---|---|
| Excellence | ≥65% | ≤0.4% | ≤2% | ≥60% | 25 | points |
| Pass | ≥60% | ≤0.5% | ≤3% | ≥57.5% | 15 | points |
| Tentative | ≥55% | ≤0.6% | ≤4% | ≥55% | 5 | points |
| Pass | | | | | | |
| Fail | Less than 55% | More than 0.6% | More than 4% | Less than 55% | 0 | point |

TABLE 6

| | | Shrinkage | | | |
|---|---|---|---|---|---|
| | Chemical Retention | Ratio | Leaching Ratio | ASE | Total Score |
| Example 10 | Excellence | Excellence | Excellence | Excellence | 100 |
| Example 11 | Tentative Pass | Excellence | Pass | Excellence | 70 |
| Example 12 | Tentative Pass | Excellence | Excellence | Excellence | 80 |
| Example 13 | Pass | Tentative | Tentative Pass | Excellence | 50 |
| | | Pass | | | |
| Example 14 | Excellence | Pass | Pass | Excellence | 80 |
| Comparative | Fail | Tentative | Fail | Fail | 5 |
| Example 4 | | Pass | | | |
| Comparative | Fail | Tentative | Fail | Fail | 5 |
| Example 5 | | Pass | | | |
| Comparative | Pass | Fail | Fail | Fail | 15 |
| Example 6 | | | | | |
| Comparative | Excellence | Fail | Fail | Fail | 25 |
| Example 7 | | | | | |

From the above results, it was confirmed that citric acid, glutaric acid and malic acid performed well in the acids. Citric acid performed particularly well in all evaluations.

### Test Examples 1 to 9

As shown in the following table, various chemical solutions adjusted to a concentration of 30% by mass were taken in an amount of 33.3 mg (so that the solid content was approximately 10 mg) and poured into aluminum pans for thermal gravimetric analysis. Using the Thermogravimetry and Differential Thermal Analyzer, TG/DTA 6200 produced by Seiko Instruments Inc., the above aluminum pans were placed in the sample chamber, and the temperature of the sample chamber was raised at a rate of 10° C./min. Dry air was continuously supplied into the sample chamber at a rate of 300 ml/min. The temperature was maintained at 100° C. for 30 minutes to evaporate the moisture of the chemical solution, and the mass at this point was used as the reference (100%) for calculating the residual ratio. The temperature was then raised to 160° C. at a rate of 10° C./min and held at 160° C. for 6 hours to promote the reaction, evaporation, and decomposition of the chemicals (citric acid and a polyol).

TABLE 7

| | | | Concentration of | |
|---|---|---|---|---|
| | | | Chemicals | Heating |
| | Chemicals | Molar Ratio | (% by mass) | Temperature |
| Test Example 1 | Citric Acid:GLYC | 1:1 | 30% | 160° C. |
| Test Example 2 | Citric Acid:EG | 1:1.5 | 30% | 160° C. |
| Test Example 3 | Citric Acid:DEG | 1:1.5 | 30% | 160° C. |
| Test Example 4 | Citric Acid:TEG | 1:1.5 | 30% | 160° C. |
| Test Example 5 | Citric Acid:PG | 1:1.5 | 30% | 160° C. |
| Test Example 6 | Citric Acid:DPG | 1:1.5 | 30% | 160° C. |
| Test Example 7 | Citric Acid:PEG200 | 1:1 | 30% | 160° C. |
| Test Example 8 | Citric Acid:PEG400 | 1:0.5 | 30% | 160° C. |
| Test Example 9 | Citric Acid:PPG400 | 1:0.5 | 30% | 160° C. |

(GLYC = glycerin, EG = ethylene glycol, DEG = diethylene glycol, TEG = triethylene glycol, PG = propylene glycol, DPG = dipropylene glycol, PEG200 = polyethylene glycol 200, PEG400 = polyethylene glycol 400, PPG400 = polypropylene glycol 400)

For each specimen, a chemical residual ratio was measured after 120 and 360 minutes.

TABLE 8

| | GLYC | EG | DEG | TEG | PG | DPG | PEG200 | PEG400 | PPG400 |
|---|---|---|---|---|---|---|---|---|---|
| Residual Ratio | 79.6 | 76.7 | 73.0 | 79.9 | 65.5 | 61.4 | 83.4 | 84.9 | 79.6 |
| after 120 minutes | | | | | | | | | |
| (Actual Value) | | | | | | | | | |
| Theoretical | 81.0 | 81.1 | 84.6 | 87.1 | 82.4 | 86.3 | 86.2 | 86.2 | 86.2 |
| Residual Ratio | | | | | | | | | |
| Actual Value/ | 98.3 | 94.6 | 86.3 | 91.8 | 79.5 | 71.2 | 96.7 | 98.5 | 92.3 |
| Theoretical Value | | | | | | | | | |
| Residual Ratio | 77.2 | 68.4 | 68.8 | 74.4 | 54.4 | 52.5 | 78.0 | 76.3 | 67.9 |
| after 360 minutes | | | | | | | | | |
| (Actual Value) | | | | | | | | | |
| Decomposition | 0.75 | 2.70 | 1.46 | 1.73 | 4.23 | 3.62 | 1.60 | 2.55 | 3.68 |
| Rate per hour | | | | | | | | | |

From the above results, it was confirmed that glycerin is a superior polyol from the viewpoint of the chemical residual ratio. Based on the change in the residual ratio curve, it was estimated that the reaction between citric acid and a polyol was completed at 120 minutes of heating at 160° C., and thus when the endpoint of the reaction was set at 120 minutes, the residual ratios were highest for PEG400 and PEG200, followed by TEG, PPG400 and glycerin. In addition, comparing the theoretical residual ratio calculated by assuming that all the carboxyl groups of citric acid and the hydroxyl groups of a polyol underwent condensation reactions with the actual residual ratio measured at 120 minutes, PEG 400 and glycerin were closest to the theoretical values, followed by PEG 200. Based on these results, PEG400, glycerin, and PEG200 are proposed as candidates. Furthermore, when heating continued at 160° C. for 240 minutes (360 minutes in total), the decrease in the residual ratio observed between 120 and 360 minutes can be assumed to be the speed at which the substances formed by the initial reaction undergo thermal decomposition. The decreasing ratio per hour during this period was 0.75% for glycerin, 1.60% for PEG 200, and 2.55% for PEG 400, suggesting that the reaction product of glycerin and citric acid is stable against heat. Based on the above results, the superiority of glycerin as a polyol was demonstrated.

### Test Examples 10 to 20

As shown in the following table, various chemical solutions adjusted to a concentration of 30% by mass by changing the mole number of glycerin to 1 mol of citric acid were taken in an amount of 33.3 mg (so that the solid content was approximately 10 mg) and poured into aluminum pans for thermal gravimetric analysis. Using the Thermogravimetry and Differential Thermal Analyzer produced by Seiko Instruments Inc., the aluminum pans were placed in the sample chamber, and the temperature of the sample chamber was raised at a rate of 10° C./min. Dry air was continuously supplied into the sample chamber at a rate of 300 ml/min. The temperature was maintained at 100° C. for 30 minutes to evaporate the moisture of the chemical solution, and the mass at this point was used as the reference (100%) for calculating the residual ratio. The temperature was then raised to 160° C. at a rate of 10° C./min and held at 160° C. for 6 hours to promote the reaction, evaporation, and decomposition of the chemicals (citric acid and glycerin).

TABLE 9

| | Test Examples No. | | | | | | | | | | |
|---|---|---|---|---|---|---|---|---|---|---|---|
| | 10 | 11 | 12 | 13 | 14 | 15 | 16 | 17 | 18 | 19 | 20 |
| GLYC Molar Ratio | 0.6 | 0.7 | 0.8 | 0.9 | 1.0 | 1.1 | 1.2. | 1.3 | 1.5 | 2.0 | 2.5 |
| Residual Ratio | 75.9 | 79.1 | 80.7 | 80.3 | 80.4 | 79.6 | 79.7 | 77.7 | 77.1 | 74.2 | 66.5 |
| after 120 minutes | | | | | | | | | | | |
| (Actual Value) | | | | | | | | | | | |
| Theoretical | 86.9 | 85.3 | 83.7 | 82.3 | 81.0 | 81.6 | 82.2 | 82.7 | 83.6 | 85.6 | 87.2 |
| Residual Ratio | | | | | | | | | | | |
| Actual Value/ | 91.0 | 94.7 | 95.9 | 97.7 | 98.3 | 97.7 | 94.6 | 93.2 | 88.7 | 77.6 | 74.3 |
| Theoretical Value | | | | | | | | | | | |
| Residual Ratio | 73.9 | 77.3 | 78.1 | 77.7 | 77.2 | 77.6 | 75.3 | 74.5 | 71.6 | 64.3 | 62.7 |
| after 360 minutes | | | | | | | | | | | |
| (Actual Value) | | | | | | | | | | | |
| Decomposition | 1.65 | 1.05 | 0.70 | 0.85 | 0.75 | 0.65 | 0.80 | 0.83 | 0.86 | 0.81 | 0.83 |
| Rate per hour | | | | | | | | | | | |

When analyzing in the same manner as the results of citric acid and polyols as described above, it was confirmed from the above results that the mole number of glycerin to 1 mole of citric acid is preferably 0.7 to 1.3, more preferably 0.8 to 1.2, even more preferably 0.9 to 1.1, and particularly preferably 1.1.

### Examples 15 to 28 and Comparative Examples 8 to 9

As shown in the following table, wood specimens of Cryptomeria japonica were immersed in a chemical solution prepared by varying the molar ratio of glycerin to citric acid and the chemical solution was allowed to penetrate sufficiently into the wood specimens using the reduced/pressurized impregnation. Then the wood specimens were taken out of the chemical solution and heat treated using a blower dryer. In more detail, the wood specimens were immersed in the chemical solution and subjected to a reduced pressure of about 50 hPa at ordinary temperature for 2 hours, followed by a pressure of 1.0 MPa for 1 hour, and then taken out of the chemical solution after releasing pressure. Then they were dried using the blower dryer at 60° C. for 48 hours, followed by 105° C. for 48 hours. The dried wood specimens were heated at 160° C. for 24 hours to allow the chemicals to react.

The results obtained were evaluated using the criteria shown in Table 4 described above, and the results are shown in the following table. When Cryptomeria japonica wood was modified in fact, excellent results were obtained when the molar ratio of citric acid to glycerin was 1:0.5 to 1:1.4.

TABLE 10

| | | Chemical | Shrinkage | Leaching | | Total |
|---|---|---|---|---|---|---|
| | Citric Acid:Glycerin | Retention | Ratio | Ratio | ASE | Score |
| Comparative | Citric Acid alone | Fail | Fail | Excellence | Excellence | 50 |
| Example 8 | | | | | | |
| Example 15 | 1:0.3 | Tentative | Excellence | Excellence | Excellence | 65 |
| | | Pass | | | | |
| Example 16 | 1:0.4 | Pass | Excellence | Excellence | Pass | 80 |
| Example 17 | 1:0.5 | Excellence | Excellence | Excellence | Pass | 80 |
| Example 18 | 1:0.6 | Excellence | Excellence | Excellence | Pass | 90 |
| Example 19 | 1:0.7 | Excellence | Excellence | Excellence | Pass | 90 |
| Example 20 | 1:0.8 | Excellence | Excellence | Excellence | Pass | 90 |
| Example 21 | 1:0.9 | Excellence | Excellence | Excellence | Pass | 90 |
| Example 22 | 1:1.0 | Excellence | Excellence | Excellence | Excellence | 100 |
| Example 23 | 1:1.1 | Excellence | Excellence | Excellence | Excellence | 100 |
| Example 24 | 1:1.2 | Excellence | Excellence | Excellence | Excellence | 100 |
| Example 25 | 1:1.3 | Excellence | Excellence | Excellence | Excellence | 100 |
| Example 26 | 1:1.4 | Excellence | Excellence | Excellence | Excellence | 100 |
| Example 27 | 1:1.5 | Excellence | Pass | Tentative | Pass | 60 |
| | | | | Pass | | |
| Example 28 | 1:1.6 | Excellence | Pass | Pass | Tentative | 60 |
| | | | | | Pass | |
| Comparative | Glycerin alone | Fail | Fail | Fail | Fail | 0 |
| Example 9 | | | | | | |

1. A method for producing a modified wood material comprising:
1) step of impregnating an untreated wood material with at least one acid selected from citric acid, malic acid and glutaric acid, and glycerin to obtain a chemical-impregnated wood material; and
2) step of heating the chemical-impregnated wood material obtained in step 1.

2. The production method according to claim 1, wherein a molar ratio of the glycerin to the total number of carboxyl groups of the acid is 0.1 to 0.5.

3. The production method according to claim 1, wherein the acid is citric acid and a molar ratio of the glycerin to the citric acid is 0.5 to 1.4.

4. The production method according to claim 1, wherein step 1 is step of impregnating the untreated wood material with an aqueous solution containing glycerin and the acid.

5. The production method according to claim 4, wherein a total concentration of the acid and glycerin in the aqueous solution is 15% by mass or more.

6. The production method according to claim 4, wherein a total concentration of the acid and glycerin in the aqueous solution is 40% by mass or less.

7. The production method according to claim 1, wherein the acid is citric acid.

8. The production method according to claim 1, wherein a heating temperature in step 2 is 130 to 180° C.

9. The production method according to claim 1, wherein the wood material is softwood.

10. The production method according to claim 1, wherein the wood material is Cryptomeria japonica or Chamaecyparis obtusa.

11. The production method according to claim 1, further comprising impregnation with a polyol in step 1.

12. The production method according to claim 11, wherein the polyol is PEG200 or PEG400.

13. A modified wood material produced by the production method according to claim 1.

14. A modified wood material comprising a reaction product of at least one acid selected from citric acid, malic acid and glutaric acid, and glycerin.

15. The modified wood material according to claim 13, used for floor materials, decks, exterior wall materials, louvers, furniture, wooden fences, guardrails, exterior construction materials, and/or musical instruments.

16. The modified wood material according to claim 14, used for floor materials, decks, exterior wall materials, louvers, furniture, wooden fences, guardrails, exterior construction materials, and/or musical instruments.
